(19) United States
(12) Patent Application Publication
(10) Pub. No.: US 2025/0240764 A1
(43) Pub. Date: Jul. 24, 2025

(54) MECHANISM FOR POSITIONING REFERENCE SIGNAL MEASUREMENTS

(71) Applicant: Nokia Technologies Oy, Espoo (FI)

(72) Inventors: Ryan KEATING, Naperville, IL (US); Oana-Elena BARBU, Aalborg (DK); Benny VEJLGAARD, Aalborg (DK); Johannes HARREBEK, Aalborg (DK); Tao TAO, Shanghai (CN); Jan Torst HVIID, Aalborg (DK)

(21) Appl. No.: 18/833,430

(22) PCT Filed: Jan. 29, 2022
(86) PCT No.: PCT/CN2022/075029

§ 371 Date: Jul. 26, 2024

(51) Int. Cl. H04W 64/00; H04B 17/318

(52) U.S. Cl. CPC H04W 64/003; H04B 17/328

(57) ABSTRACT

Embodiments of the present disclosure relate to mechanism for positioning reference signal (PRS) measurements. According to embodiments of the present disclosure, a first device determines channel metrics between the first device and a second device. The first device determines a number of PRS samples based on the channel metrics and a target accuracy for a PRS measurement. The first device transmits a report indicating a result of the PRS measurement. In this way, the number of PRS samples can be reduced based on the channel metrics, thereby saving power.

### FIELD

Embodiments of the present disclosure generally relate to the field of telecommunication and in particular, to methods, devices, apparatuses and computer readable storage medium for positioning reference signal measurements.

### BACKGROUND

With developments of communication systems, new technologies have been proposed. A recent work item has been conducted in the third generation partner project (3GPP) for positioning support in new radio (NR) system. A new reference signal for positioning has been introduced in downlink. For example, the terminal devices may measure the reference signal time difference (RSTD) between positioning reference signals (PRSs) from different transmission points in order to perform positioning. Alternatively or in addition, the terminal devices can measure a receiving-transmitting (Rx-Tx) time difference where the time difference is between two PRSs.

### SUMMARY

In general, example embodiments of the present disclosure provide a solution for positioning reference signal measurements.

In a first aspect, there is provided a first device. The first device comprises at least one processor; and at least one memory including computer program code; the at least one memory and the computer program code are configured to, with the at least one processor, cause the first device at least to: determine channel metrics between the first device and a second device; determine a number of positioning reference signal samples based on the channel metrics and a target accuracy for a positioning reference signal measurement; and perform the positioning reference signal measurement based on the number of positioning reference signal samples.

In a second aspect, there is provided a second device. The second device comprises at least one processor; and at least one memory including computer program code; the at least one memory and the computer program code are configured to, with the at least one processor, cause the second device at least to: transmit mapping information to a first device, wherein the mapping information indicates a relation among numbers of positioning reference signal samples, channel metrics and accuracies for positioning reference signal measurement; and receive from the first device a report indicating of a result of a PRS measurement, wherein the PRS measurement is performed based on a number of positioning reference signal samples and the number of positioning reference signal samples is determined based on channel metrics between the first device and the second device and a target accuracy for a positioning reference signal measurement.

In a third aspect, there is provided a method. The method comprises determining channel metrics between the first device and a second device; determining a number of positioning reference signal samples based on the channel metrics and a target accuracy for a positioning reference signal measurement; and performing the positioning reference signal measurement based on the number of positioning reference signal samples.

In a fourth aspect, there is provided a method. The method comprises transmitting, at a second device, mapping information to a first device, wherein the mapping information indicates a relation among numbers of positioning reference signal samples, channel metrics and accuracies for the PRS measurement; and receiving from the first device a report indicating of a result of a PRS measurement, wherein the PRS measurement is performed based on a number of positioning reference signal samples and the number of positioning reference signal samples is determined based on channel metrics between the first device and the second device and a target accuracy for a positioning reference signal measurement.

In a fifth aspect, there is provided an apparatus. The apparatus comprise means for determining channel metrics between the first device and a second device; means for determining a number of positioning reference signal samples based on the channel metrics and a target accuracy for a positioning reference signal measurement; and means for performing the positioning reference signal measurement based on the number of positioning reference signal samples.

In a sixth aspect, there is provided an apparatus. The apparatus comprises means for transmitting, at a second device, mapping information to a first device, wherein the mapping information indicates a relation among numbers of positioning reference signal samples, channel metrics and accuracies for the PRS measurement; and means for receiving from the first device a report indicating of a result of a PRS measurement, wherein the PRS measurement is performed based on a number of positioning reference signal samples and the number of positioning reference signal samples is determined based on channel metrics between the first device and the second device and a target accuracy for a positioning reference signal measurement.

In a seventh aspect, there is provided a computer readable medium. The computer readable medium comprises program instructions for causing an apparatus to perform at least the method according to any one of the third or fourth aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates a signaling flow for positioning reference signal measurements according to some example embodiments of the present disclosure;

FIG. 3 illustrates a schematic diagram of positioning reference signal samples according to some example embodiments of the present disclosure;

FIG. 4 illustrates a flowchart of a method implemented at a first device according to some example embodiments of the present disclosure;

FIG. 5 illustrates a flowchart of a method implemented at a first device according to some example embodiments of the present disclosure;

FIG. 6 illustrates a flowchart of a method implemented at a second device according to some example embodiments of the present disclosure;

FIG. 7 illustrates a simplified block diagram of an apparatus that is suitable for implementing example embodiments of the present disclosure; and

FIG. 8 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/of” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, an Integrated and Access Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. The term “terminal device” refers to any end device that may be capable of wireless communication. In the following description, the terms “terminal device”, “terminal”, “user equipment” and “UE” may be used interchangeably.

As mentioned above, it was conducted in 3GPP for positioning support in NR. According to conventional technologies, in order to meet low latency targets one enhancement being specified is a reduced number of PRS samples (reference signal occasions) at the UE. The reduced number of PRS samples simply sets the amount that the UE should use to meet accuracy requirements/tests. However, there is a trade of between accuracy and power consumption as the less number of samples are expected to have reduced requirements in terms of accuracy.

In NR positioning radio access network (RAN) 4 sets the positioning measurement requirements (for example, RSTD) based on a number of samples that the UE receives for the PRS. The term “sample” in RAN4 spec means the number of instances of a PRS resource (e.g., one repetition of a periodic set). The higher number of samples that a UE uses to measure the PRS will cause higher the power consumption. The higher the number of samples will achieve higher the expected positioning measurement accuracy (e.g., RSTD). So, there is a natural tradeoff between power consumption and accuracy. For low power devices (e.g., reduced capability (RedCap) UEs) this becomes a problem to hit the needed accuracy while minimizing power consumption. The needed samples to meet a certain accuracy is also related to the quality of the received signal (i.e., signals received with relatively high power and low interference will require fewer samples to reach a target accuracy).

Moreover, if the UE always needs to use the same number of measurement samples this is then power inefficient for the UE. As the UE would then need to use a higher number of samples for some PRS from some transmission reception points (TRPs) which are not needed. This leads to a waste of UE power.

In order to solve the above or other potential problems, solutions on positioning reference signal (PRS) measurements are needed. According to embodiments of the present disclosure, a first device determines channel metrics between the first device and a second device. The first device determines a number of PRS samples based on the channel metrics and a target accuracy for a PRS measurement. The first device transmits a report indicating a result of the PRS measurement. In this way, the number of PRS samples can be reduced based on the channel metrics, thereby saving power at the UE side.

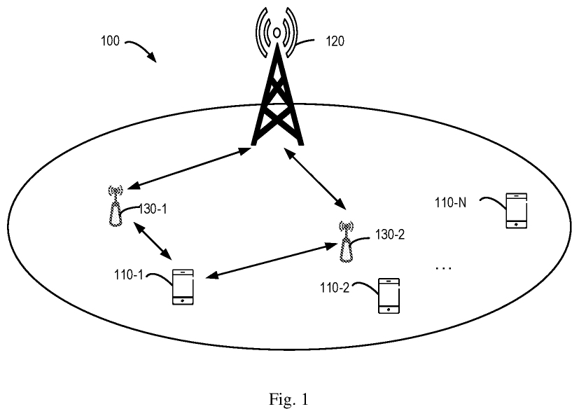

FIG. 1 illustrates an example embodiment, a schematic diagram of a communication environment 100 in which embodiments of the present disclosure can be implemented. The communication environment 100, which is a part of a communication network, further comprises a device 110-1, a device 110-2, . . . , a device 110-N, which can be collectively referred to as “first device(s) 110.” The communication environment 100 comprises a second device 120. As shown in FIG. 1, for example, the second device 120 may communicate with the first device 110 via TRPs 130-1 and 130-2 (collectively referred to as “TRPs 130” or individually referred to as “TRP 130” in the following). For example, the TRP 130-1 may be also referred to as the first TRP, while the TRP 130-2 may be also referred to as the second TRP.

The communication environment 100 may comprise any suitable number of devices and cells. In the communication environment 100, the first device 110 and the second device 120 can communicate data and/or control information to each other. In the case that the first device 110 is the terminal device and the second device 120 is the network device, a link, i.e. the communication of data and/or control, from the second device 120 to the first device 110 is referred to as a downlink (DL), while a link from the first device 110 to the second device 120 is referred to as an uplink (UL).

It is to be understood that the number of first devices and cells and their connections shown in FIG. 1 is given for the purpose of illustration without suggesting any limitations. The communication environment 100 may include any suitable number of devices and networks adapted for implementing embodiments of the present disclosure.

Communications in the communication environment 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

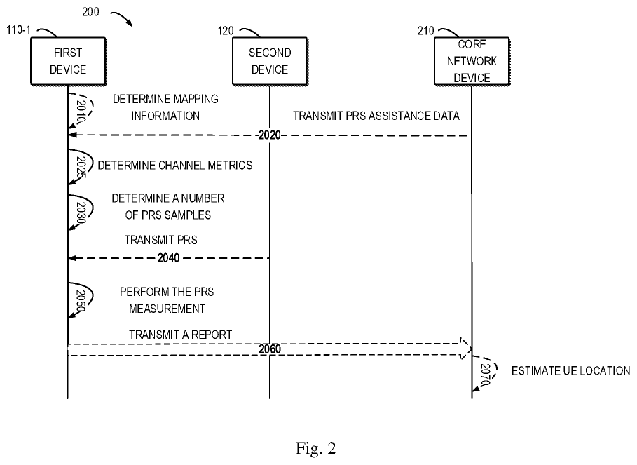

Reference is now made to FIG. 2, which illustrates a signaling flow 200 for PRS measurements according to example embodiments of the present disclosure. For the purpose of discussion, the signaling flow 200 will be described with reference to FIG. 1. Only for the purpose of illustrations, the signaling flow 200 may involve the first device 110-1 and the second device 120. Embodiments of the present disclosure can be applied to any proper types of devices, including, RedCap devices. The RedCap devices are designed with relatively longer battery life as compared to internet of thing (IoT). One such RedCap feature to extend battery life is radio resource management (RRM) relaxations for RedCap devices. Moreover, embodiments of the present disclosure can be applied to different beams or TRPs.

The first device 110-1 may determine 2010 mapping information which indicates a relation among number of positioning reference signal (PRS) samples, channel metrics and accuracies for the PRS measurement. In some embodiments, the mapping information can be determined at the first device 110-1. Alternatively, determining the mapping information may comprise receiving the mapping information from the second device. In other words, the second device 120 may transmit the mapping information to the first device 110-1.

In some embodiments, the mapping information may be maintained in a look-up table. Alternatively, the mapping information may be maintained in a multi-variable function. In some other embodiments, the mapping information may be maintained in other adaptive routine.

The channel metrics may comprise any proper parameters which indicate a link quality between devices. For example, in some example embodiments, the channel metrics may indicate a line of sight (LoS) state. Alternatively or in addition, the channel metrics may indicate a signal to interference and noise ratio (SINR). In other embodiments, the channel metrics may indicate a reference signal received power (RSRP). In some other embodiments, the channel metrics may indicate a reference signal received quality (RSRQ).

The positioning reference signal (PRS) may be a main reference signal supporting downlink-based positioning methods. The term “PRS sample” used herein can refer to an instance/occasion of the PRS signal which is repeated. For example, one instance of a PRS resource set which has a priority of 10 ms would have 4 samples within a 40 ms window. Using PRS may have a benefit of having good levels of accuracy, coverage, and interference avoidance and suppression and a large delay spread range, since it may be received from potentially distant neighboring base stations for position estimation. This may be achieved by covering wide range or the whole range NR bandwidth and transmitting PRS over multiple symbols that may be aggregated to accumulate power.

Table 1 below shows example mapping information among number of PRS samples, channel metrics and accuracies for the PRS measurement. It should be noted that the values of accuracies, channel metrics and the number of PRS samples in Table 1 are only examples not limitations.

TABLE 1

| Target | Current | |
|---|---|---|
| Accuracy | Conditions (e.g., | Minimum number of |
| (RSTD) | SINR, LOS) | samples |
| +/− 25 ns | <0 dB, LoS, . . . | 1 |
| +/− 25 ns | −3 dB, LoS, . . . | 3 |
| +/− 10 ns | 0 dB, LoS, . . . | 2 |
| +/− 10 ns | −3 dB, LoS, . . . | 4 |

The first device 110-1 may obtain PRS assistance data. For example, the core network device 210 may transmit 2020 the PRS assistance data to the first device 110-1. In some embodiments, the core network device 210 can be or comprise a location management function (LMF). In one example embodiment, LMF may be a separate unit from the core network device and LMF is in communication connection with the core network device.

The PRS assistance data may comprise parameters for the PRS. For example, the PRS assistance data may comprise a bandwidth of the PRS. Alternatively or in addition, the PRS assistance data may comprise a periodicity of the PRS. In some embodiments, the PRS assistance data may comprise a density of subcarrier occupied in a given PRS symbol which is referred to as the comb size. For comb-N PRS, N symbols can be combined to cover all the subcarriers in the frequency domain. Each base station can then transmit in different sets of subcarriers to avoid interference.

The first device 110-1 determines 2025 channel metrics between the first device 110-1 and the second device 120. For example, the first device 110-1 may determine the channel metrics between the first device 110-1 and the TRP 130-1. The first device 110-1 may also determine the channel metrics between the first device 110-1 and the TRP 130-2.

As mentioned above, the channel metrics may indicate at least one of: a LoS state, a SINR, a RSRP, or a RSRQ. The first device 110-1 can determine the channel metrics based on any proper signals. For example, the channel metrics can be determined based on a synchronization signal/physical broadcast channel (SSB). Alternatively, the first device 110-1 may determine the channel metrics based on PRS. In this case, the channel metrics can be determined based on a previous measurement of the PRS. In other words, the first device 110-1 may use the PRS which has been received previously to determine the channel metrics.

The first device 110-1 determines 2030 a number of PRS samples based on the channel metrics and a target accuracy of the PRS measurement. For example, in some embodiments, the first device 110-1 can determine the number of PRS samples based on the channel metrics, the target accuracy and the mapping information. In some other embodiments, the first device 110-1 can determine the number of PRS samples based on a quasi co-located signal which has been received.

In some embodiments, the target accuracy of the PRS measurement may be determined based on quality of service (QoS) requirements. QoS can refer to the measurement of the overall performance of a service experienced by the users of the network. To quantitatively measure at least one of the QoS packet loss, bit rate, throughput, transmission delay, availability, jitter or other related aspects of service can be considered. In some embodiments, the first device 110-1 can determine the target accuracy of the PRS measurement. Alternatively, the first device 110-1 may receive an indication of the target accuracy from the core network device 210.

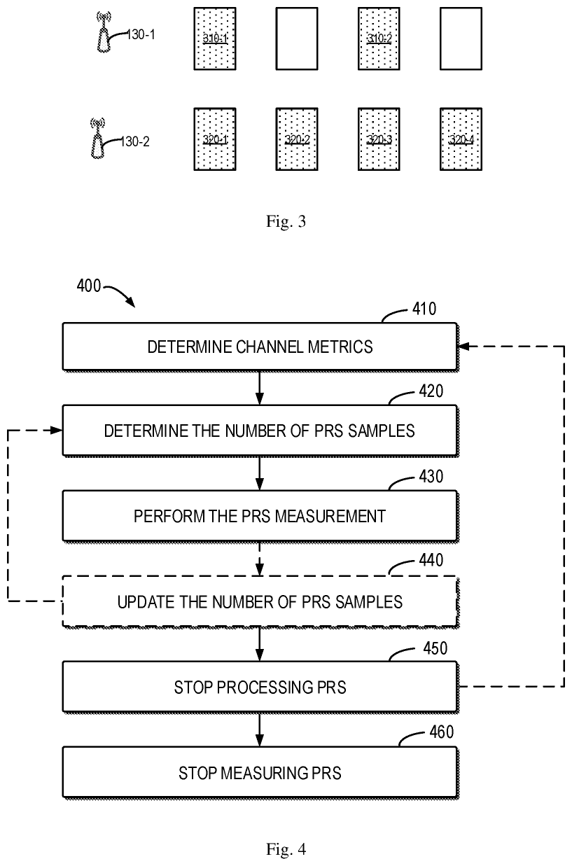

Referring to FIG. 3, the first device 110-1 may determine that the SINR between the first device 110-1 and the TRP 130-1 is 0 dB. The target accuracy for the PRS measurement associated with the TRP 130-1 is +/−10 ns. In this case, the first device 110-1 may determine that the number of PRS samples is 2 according to Table 1, which are shown as PRS samples 310-1 and 310-2. Moreover, the first device 110-1 may determine that the SINR between the first device 110-1 and the TRP 130-2 is −3 dB. The target accuracy for the PRS measurement associated with the TRP 130-1 is +/−10 ns. In this case, the first device 110-1 may determine that the number of PRS samples is 4 according to Table 1, which are shown as PRS samples 320-1, 320-2, 320-3 and 320-4. In other words, the channel condition between the first device 110-1 and the TRP 130-1 is better than the channel condition between the first device 110-1 and the TRP 130-2, the first device 110-1 may use less PRS samples for the PRS measurement associated with the TRP 130-1 than the PRS measurement associated with the TRP 130-2. In this way, first device 110-1 may consume less power.

The second device 120 can transmit 2040 a set of positioning reference signals to the first device 110-1. For example, there are several configurable comb-based PRS patterns for comb-2, 4, 6 and 12 suitable for different scenarios serving different use cases. The PRS can also support 2/4/6/12 symbols in time frequency. Table 2 below shows example patterns for the PRS. It should be noted that Table 2 is only an example not limitation.

TABLE 2

| | 2 symbols | 4 symbols | 6 symbols | 12 symbols |
|---|---|---|---|---|
| Comb2 | 0, 1 | 0, 1, 0, 1 | 0, 1, 0, 1, 0, 1 | 0, 1, 0, 1, 0, 1, |
| | | | | 0, 1, 0, 1, 0, 1 |
| Comb4 | NA | 0, 2, 1, 3 | NA | 0, 2, 1, 3, 0, 2, |
| | | | | 1, 3, 0, 2, 1, 3 |
| Comb6 | NA | NA | 0, 3, 1, 4, 2, 5 | 0, 3, 1, 4, 2, 5, |
| | | | | 0, 3, 1, 4, 2, 5 |
| Comb12 | NA | NA | NA | 0. 6, 3, 9, 1, 7, |
| | | | | 4, 10, 2, 8, 5, 11 |

The first device 110-1 performs 2050 the PRS measurement based on the number of PRS samples. In other words, the first device 110-1 may decrease the number of measurements to reach the target accuracy. After the target accuracy is satisfied, the first device 110-1 may stop receiving or processing the PRS, thereby saving power. In some embodiments, the above channel metric may be determined based on the PRS measurement of the first PRS sample from the PRS samples.

Referring to FIG. 3, the first device 110-1 may perform the PRS measurement on the PRS signals received from the TRP 130-1 in the PRS samples 310-1 and 310-2. The first device 110-1 may perform the PRS measurement on the PRS signals received from the TRP 130-2 in the PRS samples 320-1, 320-2, 320-3 and 320-4.

When the first device 110-1 determines that it can stop receiving/processing the PRS there is some subtlety as the first device 110-1 may determine different times for stopping processing and stopping receiving the PRS. The reason for this is two-fold: 1) the first device 110-1 may be receiving multiple PRS within one symbol and continues receiving the PRS from other TRPs after it has reached the number of needed samples for a particular PRS; 2) the first device 110-1 may be using the same Rx beam to receive multiple PRS and therefore still uses an Rx beam longer than just for one PRS. In these cases, the first device 110-1 may stop processing the PRS which has reached the needed number of samples but won't technically stop receiving it until the processing is done for some more or all PRS in those symbols/Rx beam.

In some embodiments, the first device 110-1 may perform the PRS-RSRP measurement on the PRS samples. Alternatively, the first device 110-1 may perform the PRS-reference signal received path power (PRS-RSRPP) measurement on the PRS samples. In other embodiments, the first device 110-1 may perform the PRS reference signal time difference (RSTD) measurement. As another example, the first device 110-1 may perform the UE receiving-transmitting (RX-TX) time difference measurement on the PRS samples. In some embodiments, the first device 110-1 may perform at least one of the followings on the PRS samples: an angle of arrival measurement, an angle of departure measurement or a carrier phase measurement.

In some embodiments, the second device 120 may transmit performance information to the first device 110-1. In this case, the first device 110-1 may update the number of PRS samples based on the performance information. For example, if the second device 120 signals performance degradation, the mapping information can be updated to a more conservative set of values e.g., the minimum number of samples is increased by a fixed value.

In some other embodiments, the mapping information can be updated based on periodic checks of the validity of the mapping information. For example, in case a static mapping (i.e., the mapping information) is implemented, a dynamic mapping may be periodically triggered and the results of applying both methods on the same PRS are compared. In case of relevant performance difference, the static mapping can be updated according to the configuration given by the dynamic mapping. In other words, the minimum number of samples in the lookup table may be updated to match the number of samples after which the dynamic method has converged.

Reference is made to FIG. 4 which shows an example embodiment of a flowchart of updating the PRS samples. At block 410, the first device 110-1 can determine the channel metrics for a TRP/beam. As mentioned above, the channel metrics may indicate at least one of: a LoS state, a SINR, a RSRP, or a RSRQ. At block 420, the first device 110-1 determines a number of PRS samples based on the channel metrics and a target accuracy of the PRS measurement. At block 430, the first device 110-1 can perform the PRS measurement based on the number of PRS samples.

At block 440, the first device 110-1 can update the number of PRS samples. In some embodiments, the first device 110-1 may update the number of PRS samples based on variance of the PRS measurements which have been performed. For example, if the number of PRS samples is 4, the first device 110-1 can obtain the first time of arrival (TOA) estimation based on the first PRS and obtain the second TOA estimation based on the second PRS. In this case, the first device 110-1 can compare the first TOA estimation and the second TOA estimation. If the TOA has converged based on the first TOA estimation and the second TOA estimation, the first device 110-1 may stop the PRS measurement and return the TOA. In this case, the first device 110-1 can update the number of PRS samples from 4 to 2. If the TOA has not converged based on the first TOA estimation and the second TOA estimation, the first device 110-1 may obtain the third TOA estimation based on the third PRS. If the TOA has converged based on the second TOA estimation and the third TOA estimation, the first device 110-1 may stop the PRS measurement and return the TOA. In this case, the first device 110-1 can update the number of PRS samples from 4 to 3. Alternatively, the first device 110-1 may further perform the PRS measurement on the fourth PRS.

At block 450, the first device 110-1 can stop processing PRS from the TRP/beam. Blocks 410-450 can be repeated for all TRPs or all beams of one TRP. At block 460, if the first device 110-1 is beamforming, the first device 110-1 can stop measuring PRS with RX beam after all PRS beams/TRPs in that RX beam are stopped processing. Block 460 can be repeated for all UE RX beams.

In some embodiments, if the number of PRS samples is reached, the first device 110-1 may exit a measurement gap for the PRS measurement. Alternatively, the first device 110-1 may prioritize the PRS measurement within the measurement gap based on the channel metrics. For example, the first device 110-1 may firstly perform the PRS measurement within the measurement gap. In other words, the first device 110-1 may exit the measurement gap (MG) or prioritize certain TRP/beams in certain MG instances in order to reduce the time the first device 110-1 needs to spend in MG total.

Referring back to FIG. 2, the first device 110-1 may transmit 2060 a report indicating a result of the PRS measurement for the TRP/beam. In some embodiments, the report can be transmitted to the second device 120 and then forwarded to the core network device 210. Alternatively or additionally, the report can be transmitted to the core network device 210. Alternatively or additionally, the report may be transmitted or provided to the LMF (not shown in FIG. 2). In some embodiments, the core network device 210 can estimate 2070 the location of the first device 110-1 based on the report.

In some example embodiments, UE-based positioning can be applied. In this case, the first device 110-1 may determine its location locally based on the PRS measurement. The first device 110-1 may not need to transmit the report to the second device 120 or the core network device 210.

According to embodiments of FIG. 2, the first device 110-1 is able to determine the number of PRS samples based on the channel metrics. In this case, if the channel condition is good enough, the first device 110-1 may measure a smaller number of PRS samples. (In other words, if channel condition is worse, more PRS samples may be measured.) In other words, the first device 110-1 does not need to measure the same number of positioning reference signals for all TRPs, thereby saving power.

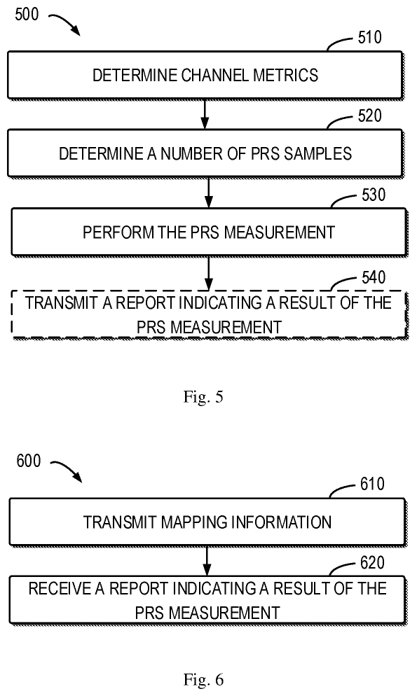

FIG. 5 shows a flowchart of an example method 500 in accordance with some example embodiments of the present disclosure. For the purpose of discussion, the method 500 will be described from the perspective of the first device 110-1.

The first device 110-1 may determine mapping information which indicates a relation among number of positioning reference signal (PRS) samples, channel metrics and accuracies for the PRS measurement. In some embodiments, the mapping information can be determined at the first device 110-1. Alternatively, determining the mapping information may comprise receiving the mapping information from the second device. In other words, the second device 120 may transmit the mapping information to the first device 110-1.

In some embodiments, the mapping information may be maintained in a look-up table. Alternatively, the mapping information may be maintained in a multi-variable function. In some other embodiments, the mapping information may be maintained in other adaptive routine.

The channel metrics can comprise any proper parameters which indicate a link quality between devices. For example, in some embodiments, the channel metrics may indicate a line of sight (LoS) state. Alternatively or in addition, the channel metrics may indicate a signal to interference and noise ratio (SINR). In other embodiments, the channel metrics may indicate a reference signal received power (RSRP). In some other embodiments, the channel metrics may indicate a reference signal received quality (RSRQ).

The PRS can be a main reference signal supporting downlink-based positioning methods. The term “PRS sample” used herein can refer to an instance/occasion of the PRS signal which is repeated. Using PRS may have a benefit of having good levels of accuracy, coverage, and interference avoidance and suppression and a large delay spread range, since it may be received from potentially distant neighboring base stations for position estimation. This may be achieved by covering the wide range/whole NR bandwidth and transmitting PRS over multiple symbols that can be aggregated to accumulate power.

The first device 110-1 may obtain PRS assistance data. For example, the core network device 210 may transmit 2020 the PRS assistance data to the first device 110-1. In some embodiments, the core network device 210 can be or comprise a location management function (LMF). In one example embodiment, LMF may be a separate unit from the core network device and LMF is in communication connection with the core network device.

The PRS assistance data may comprise parameters for the PRS. For example, the PRS assistance data may comprise a bandwidth of the PRS. Alternatively or in addition, the PRS assistance data may comprise a periodicity of the PRS. In some embodiments, the PRS assistance data may comprise a density of subcarrier occupied in a given PRS symbol which is referred to as the comb size. For comb-N PRS, N symbols can be combined to cover all the subcarriers in the frequency domain. Each base station can then transmit in different sets of subcarriers to avoid interference.

At block 510, the first device 110-1 determines channel metrics between the first device 110-1 and the second device 120. As mentioned above, the channel metrics may indicate one or more of: a LoS state, a SINR, a RSRP, or a RSRQ. The first device 110-1 can determine the channel metrics based on any proper signals. For example, the channel metrics can be determined based on a synchronization signal/physical broadcast channel (SSB). Alternatively, the first device 110-1 may determine the channel metrics based on PRS. In this case, the channel metrics can be determined based on a previous measurement of the PRS. In other words, the first device 110-1 may use the PRS which has been received previously to determine the channel metrics.

At block 520, the first device 110-1 determines a number of PRS samples based on the channel metrics and a target accuracy of the PRS measurement. For example, in some embodiments, the first device 110-1 can determine the number of PRS samples based on the channel metrics, the target accuracy and the mapping information. In some other embodiments, the first device 110-1 can determine the number of PRS samples based on a quasi co-located signal which has been received.

In some embodiments, the target accuracy of the PRS measurement can be determined based on quality of service (QoS) requirements. QoS can refer to the measurement of the overall performance of a service experienced by the users of the network. To quantitatively measure at least one of the QoS packet loss, bit rate, throughput, transmission delay, availability, jitter and other related aspects of service can be considered. In some embodiments, the first device 110-1 can determine the target accuracy of the PRS measurement. Alternatively, the first device 110-1 may receive an indication of the target accuracy from the core network device 210.

The first device 110-1 can receive a set of positioning reference signals from the second device 120. For example, there are several configurable comb-based PRS patterns for comb-2, 4, 6 and 12 suitable for different scenarios serving different use cases. The PRS can also support 2/4/6/12 symbols in time frequency.

At block 530, the first device 110-1 performs the PRS measurement based on the number of PRS samples. In other words, the first device 110-1 may only use the minimum number of measurements to reach the target accuracy. After the target accuracy is satisfied, the first device 110-1 may stop receiving or processing the PRS, thereby saving power. In some embodiments, the above channel metric may be determined based on the PRS measurement of the first PRS sample from the PRS samples.

When the first device 110-1 determines that it can stop receiving/processing the PRS there is some subtlety as the first device 110-1 may determine different times for stopping processing and stopping receiving the PRS. The reason for this is two-fold: 1) the first device 110-1 may be receiving multiple PRS within one symbol and needs to continue receiving the PRS from other TRPs after it has reached the number of needed samples for a particular PRS; 2) the first device 110-1 may be using the same Rx beam to receive multiple PRS and therefore need to still use an Rx beam longer than just for one PRS. In these cases, the first device 110-1 can stop processing the PRS which has reached the needed number of samples but won't technically stop receiving it fully until the processing is done for some more or all PRS in those symbols/Rx beam.

In some embodiments, the first device 110-1 may perform the PRS-RSRP measurement on the PRS samples. Alternatively, the first device 110-1 may perform the PRS-reference signal received path power (PRS-RSRPP) measurement on the PRS samples. In other embodiments, the first device 110-1 may perform the PRS reference signal time difference (RSTD) measurement. As another example, the first device 110-1 may perform the UE receiving-transmitting (RX-TX) time difference measurement on the PRS samples. In some embodiments, the first device 110-1 may perform at least one of the followings on the PRS samples: an angle of arrival measurement, an angle of departure measurement or a carrier phase measurement.

In some embodiments, the first device 110-1 may receive performance information from the second device 120. In this case, the first device 110-1 may update the number of PRS samples based on the performance information. For example, if the second device 120 signals performance degradation, the mapping information can be updated to a more conservative set of values e.g., the minimum number of samples is increased by a fixed value.

In some other embodiments, the mapping information can be updated based on periodic checks of the validity of the mapping information. For example, in case a static mapping (i.e., the mapping information) is implemented, a dynamic mapping may be periodically triggered and the results of applying both methods on the same PRS are compared. In case of relevant performance difference, the static mapping can be updated according to the configuration given by the dynamic mapping. In other words, the minimum number of samples in the lookup table may be updated to match the number of samples after which the dynamic method has converged.

In some embodiments, if the number of PRS samples is reached, the first device 110-1 may exit a measurement gap for the PRS measurement. Alternatively, the first device 110-1 may prioritize the PRS measurement within the measurement gap based on the channel metrics. In other words, the first device 110-1 may exit the measurement gap (MG) or prioritize certain TRP/beams in certain MG instances in order to reduce the time the first device 110-1 needs to spend in MG total.

In some embodiments, at block 540, the first device 110-1 may transmit a report indicating a result of the PRS measurement for the TRP/beam. In some embodiments, the report can be transmitted to the second device 120 and then forwarded to the core network device 210. Alternatively or additionally, the report can be transmitted to the core network device 210. Alternatively or additionally, the report may be transmitted or provided to the LMF.

In some example embodiments, UE-based positioning can be applied. In this case, the first device 110-1 may determine its location locally based on the PRS measurement. The first device 110-1 may not need to transmit the report to the second device 120 or the core network device 210.

FIG. 6 shows a flowchart of an example method 600 in accordance with some example embodiments of the present disclosure. For the purpose of discussion, the method 600 will be described from the perspective of the second device 120.

At block 610, the second device 120 transmits mapping information which indicates a relation among number of positioning reference signal (PRS) samples, channel metrics and accuracies for the PRS measurement.

In some embodiments, the mapping information may be maintained in a look-up table. Alternatively, the mapping information may be maintained in a multi-variable function. In some other embodiments, the mapping information may be maintained in other adaptive routine.

The channel metrics can comprise any proper parameters which indicate a link quality between devices. For example, in some embodiments, the channel metrics may indicate a line of sight (LoS) state. Alternatively or in addition, the channel metrics may indicate a signal to interference and noise ratio (SINR). In other embodiments, the channel metrics may indicate a reference signal received power (RSRP). In some other embodiments, the channel metrics may indicate a reference signal received quality (RSRQ).

The PRS can be a main reference signal supporting downlink-based positioning methods. The term “PRS sample” used herein can refer to an instance/occasion of the PRS signal which is repeated. Using PRS may have a benefit of having good levels of accuracy, coverage, and interference avoidance and suppression and a large delay spread range, since it may be received from potentially distant neighboring base stations for position estimation. This may be achieved by covering the wide range/whole NR bandwidth and transmitting PRS over multiple symbols that can be aggregated to accumulate power.

The second device 120 can transmit a set of positioning reference signals to the first device 110-1. For example, there are several configurable comb-based PRS patterns for comb-2, 4, 6 and 12 suitable for different scenarios serving different use cases. The PRS can also support 2/4/6/12 symbols in time frequency.

In some embodiments, the second device 120 may transmit performance information to the first device 110-1. In this case, the first device 110-1 may update the number of PRS samples based on the performance information. For example, if the second device 120 signals performance degradation, the mapping information can be updated to a more conservative set of values e.g., the minimum number of samples is increased by a fixed value.

At block 620, the second device 120 receives a report indicating a result of the PRS measurement for the TRP/beam. In some embodiments, the report can be transmitted to the second device 120 and then forwarded to the core network device 210. Alternatively or additionally, the report can be transmitted to the core network device 210. Alternatively or additionally, the report may be transmitted or provided to the LMF.

In some example embodiments, an apparatus capable of performing any of the method 500 (for example, the first device 110) may comprise means for performing the respective operations of the method 500. The means may be implemented in any suitable form. For example, the means may be implemented in a circuitry or software module. The first apparatus may be implemented as or included in the first device 110. In some example embodiments, the means may comprise at least one processor and at least one memory including computer program code. The at least one memory and computer program code are configured to, with the at least one processor, cause performance of the apparatus.

In some embodiments, the apparatus comprises means for determining channel metrics between the first device and a second device; means for determining a number of positioning reference signal samples based on the channel metrics and a target accuracy for a positioning reference signal measurement; and means for performing the positioning reference signal measurement based on the number of positioning reference signal samples.

In some embodiments, the apparatus comprises means for transmitting to the second device a report indicating of a result of the PRS measurement.

In some embodiments, the apparatus comprises means for receiving, from the second device, mapping information indicating a relation among numbers of positioning reference signal samples, channel metrics and accuracies for the PRS measurement.

In some embodiments, the apparatus comprises means for determining the number of positioning reference signal samples based on the channel metrics, the target accuracy and the mapping information.

In some embodiments, the apparatus comprises means for determining the target accuracy for the PRS measurement based on a quality of service (QoS) requirement between the first device and the second device.

In some embodiments, the apparatus comprises means for receiving an indication of the target accuracy for the PRS measurement from a core network device.

In some embodiments, the channel metrics indicate at least one of: a line of sight (LoS) status, a signal to interference and noise ratio (SINR), a reference signal received power (RSRP), or a reference signal received quality (RSRQ).

In some embodiments, the apparatus comprises means for determining the channel metrics based on a previous measurement of positioning reference signal.

In some embodiments, the apparatus comprises means for dynamically updating the number of positioning reference signal samples based on the PRS measurement.

In some embodiments, the apparatus comprises means for receiving from the second device performance information; and updating the number of positioning reference signal samples based on the performance information.

In some embodiments, the apparatus comprises means for in accordance with a determination that the target accuracy is satisfied, stopping receiving or processing subsequent positioning reference signals.

In some embodiments, the apparatus comprises means for in accordance with a determination that the number of positioning reference signal samples is reached, exiting a measurement gap for the PRS measurement.

In some embodiments, the apparatus comprises means for prioritizing the PRS measurement within a measurement gap based on the channel metrics.

In some embodiments, the apparatus comprises means for determining the number of positioning reference signal samples based on a received quasi co-located signal.

In some embodiments, the PRS measurement comprises at least one of: a PRS-RSRP measurement, a PRS-reference signal received path power (PRS-RSRPP) measurement, a PRS reference signal time difference (RSTD) measurement, a user equipment (UE) receiving-transmitting time difference measurement, an angle of arrival measurement, an angle of departure measurement, or a carrier phase measurement.

In some embodiments, the apparatus comprises means for determining a receiving beam; and in accordance with a determination that the number of positioning reference signal samples is reached, stopping the PRS measurement on the receiving beam.

In some embodiments, the first device comprises a terminal device and the second device comprises a network device.

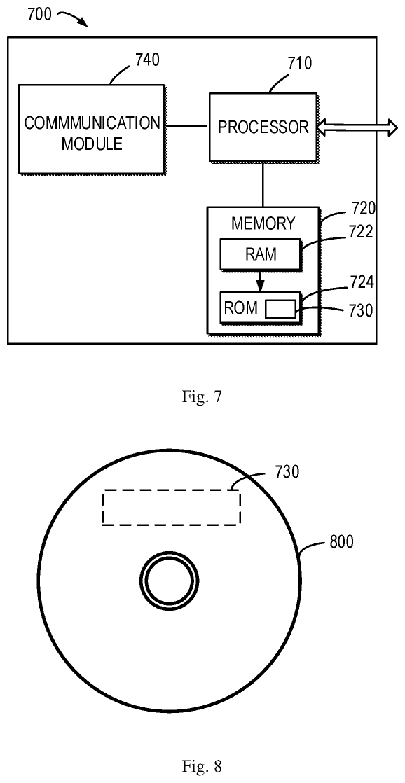

FIG. 7 is a simplified block diagram of a device 700 that is suitable for implementing example embodiments of the present disclosure. The device 700 may be provided to implement a communication device, for example, the first device 110 or the second device 120 as shown in FIG. 1. As shown, the device 700 includes one or more processors 710, one or more memories 720 coupled to the processor 710, and one or more communication modules 740 coupled to the processor 710.

The communication module 740 is for bidirectional communications. The communication module 740 has one or more communication interfaces to facilitate communication with one or more other modules or devices. The communication interfaces may represent any interface that is necessary for communication with other network elements. In some example embodiments, the communication module 740 may include at least one antenna.

The processor 710 may be of any type suitable to the local technical network and may include one or more of the following: general purpose computers, special purpose computers, microprocessors, digital signal processors (DSPs) and processors based on multicore processor architecture, application specific integrated circuits (ASICs), as non-limiting examples. The device 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a Read Only Memory (ROM) 724, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 722 and other volatile memories that will not last in the power-down duration.

A computer program 730 includes computer executable instructions that are executed by the associated processor 710. The program 730 may be stored in the memory, e.g., ROM 724. The processor 710 may perform any suitable actions and processing by loading the program 730 into the RAM 722.

Example embodiments of the present disclosure may be implemented by means of the program 730 so that the device 700 may perform any process of the disclosure as discussed with reference to FIGS. 2 to 6. The example embodiments of the present disclosure may also be implemented by hardware or by a combination of software and hardware.

In some example embodiments, the program 730 may be tangibly contained in a computer readable medium which may be included in the device 700 (such as in the memory 720) or other storage devices that are accessible by the device 700. The device 700 may load the program 730 from the computer readable medium to the RAM 722 for execution. The computer readable medium may include any types of tangible non-volatile storage, such as ROM, EPROM, a flash memory, a hard disk, CD, DVD, and other magnetic storage and/or optical storage. FIG. 8 shows an example of the computer readable medium 700 in form of an optical storage disk. The computer readable medium has the program 730 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target physical or virtual processor, to carry out any of the methods as described above with reference to FIGS. 2 to 6. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A first device comprising:
at least one processor; and
at least one memory including computer program code;
the at least one memory and the computer program code are configured to, with the at least one processor, cause the first device at least to:
determine channel metrics between the first device and a second device;
determine a number of positioning reference signal (PRS) samples based on the channel metrics and a target accuracy for a positioning reference signal measurement; and
perform the positioning reference signal measurement based on the number of positioning reference signal samples.

2. The first device of claim 1, wherein the at least one memory and the computer program code are configured to, with the at least one processor, further cause the first device at least to:
receive, from the second device, mapping information indicating a relation among numbers of positioning reference signal samples, channel metrics and accuracies for the PRS measurement.

3. The first device of claim 2, wherein the at least one memory and the computer program code are configured to, with the at least one processor, cause the first device to determine the number of positioning reference signal samples by:
determining the number of positioning reference signal samples based on the channel metrics, the target accuracy and the mapping information.

4. The first device of claim 1, wherein the at least one memory and the computer program code are configured to, with the at least one processor, further cause the first device at least to:
determine the target accuracy for the PRS measurement based on a quality of service (QoS) requirement between the first device and the second device.

5. The first device of claim 1, wherein the at least one memory and the computer program code are configured to, with the at least one processor, further cause the first device at least to:
receive an indication of the target accuracy for the PRS measurement from a core network device.

6. The first device of claim 1, wherein the channel metrics indicate at least one of:
a line of sight (LoS) status,
a signal to interference and noise ratio (SINR),
a reference signal received power (RSRP), or
a reference signal received quality (RSRQ).

7. The first device of claim 1, wherein the at least one memory and the computer program code are configured to, with the at least one processor, cause the first device to determine the channel metrics by:
determining the channel metrics based on a previous measurement of positioning reference signal.

8. The first device of claim 1, wherein the at least one memory and the computer program code are configured to, with the at least one processor, further cause the first device at least to:
dynamically update the number of positioning reference signal samples based on the PRS measurement.

9. The first device of claim 1, wherein the at least one memory and the computer program code are configured to, with the at least one processor, further cause the first device at least to:
receive from the second device performance information; and
update the number of positioning reference signal samples based on the performance information.

10. The first device of claim 1, wherein the at least one memory and the computer program code are configured to, with the at least one processor, further cause the first device at least to:
in accordance with a determination that the target accuracy is satisfied, stop receiving or processing subsequent positioning reference signals.

11. The first device of claim 1, wherein the at least one memory and the computer program code are configured to, with the at least one processor, further cause the first device at least to:
in accordance with a determination that the number of positioning reference signal samples is reached, exit a measurement gap for the PRS measurement.

12. The first device of claim 1, wherein the at least one memory and the computer program code are configured to, with the at least one processor, further cause the first device at least to:
prioritize the PRS measurement within a measurement gap based on the channel metrics.

13. The first device of claim 1, wherein the at least one memory and the computer program code are configured to, with the at least one processor, cause the first device to determine the number of positioning reference signal samples by:
determining the number of positioning reference signal samples based on a received quasi co-located signal.

14. The first device of claim 1, wherein the PRS measurement comprises at least one of:
a positioning reference signal-reference signal received power (PRS-RSRP) measurement,
a PRS-reference signal received path power (PRS-RSRPP) measurement,
a PRS reference signal time difference (RSTD) measurement,
a user equipment (UE) receiving-transmitting time difference measurement,
an angle of arrival measurement,
an angle of departure measurement, or
a carrier phase measurement.

15. The first device of claim 1, wherein the at least one memory and the computer program code are configured to, with the at least one processor, further cause the first device at least to:
determine a receiving beam; and
in accordance with a determination that the number of positioning reference signal samples is reached, stop the PRS measurement on the receiving beam.

16. The first device of claim 1, wherein the at least one memory and the computer program code are configured to, with the at least one processor, further cause the first device at least to:
transmit to the second device a report indicating of a result of the PRS measurement.

17. The first device of claim 1, wherein the first device comprises a terminal device and the second device comprises a network device.

18. A method comprising:
determining, at a first device, channel metrics between the first device and a second device;
determining, at the first device, a number of positioning reference signal (PRS) samples based on the channel metrics and a target accuracy for a positioning reference signal measurement; and
performing the positioning reference signal measurement based on the number of positioning reference signal samples.

19. The method of claim 18, further comprising:
receiving, from the second device, mapping information indicating a relation among numbers of positioning reference signal samples, channel metrics and accuracies for the PRS measurement.

20. The method of claim 19, wherein determining the number of positioning reference signal samples comprises:
determining the number of positioning reference signal samples based on the channel metrics, the target accuracy and the mapping information.

21-36. (canceled)
